(19) United States
(12) Patent Application Publication
(10) Pub. No.: US 2011/0009145 A1
(43) Pub. Date: Jan. 13, 2011

(54) METHOD AND NETWORK ARRANGEMENT FOR RE-ALLOCATING FREQUENCY RESOURCES BETWEEN CO-LOCATED CELLULAR NETWORKS

(75) Inventor: Pekka Pirinen, Oulu (FI)

Correspondence Address: YOUNG & THOMPSON, 209 Madison Street, Suite 500, Alexandria, VA, 22314, US

(73) Assignee: ELECTROBIT WIRELESS CORPORATION OY, Oulu (FI)

(21) Appl. No.: 12/918,537

(22) PCT Filed: Feb. 20, 2008
(86) PCT No.: PCT/FI08/50076

§ 371 Date: Aug. 20, 2010

(51) Int. Cl. H04B 7/00

(52) U.S. Cl. 455/509

(57) ABSTRACT

The invention relates to a method and a network arrangement for re-allocating frequency resources for terminal devices of co-located cellular networks. The co-located cellular networks can temporally release at least a part of their frequency resources at another cellular network's disposal. For accomplishing the reallocation cellular terminals camping in these co-locating cellular networks utilize in their access bursts a complementary code set. The complementary code set can comprise an operator specific signature and a terminal device specific signature. Each of the co-located networks can by correlation identify also terminal devices of other co-locating cellular networks. If the serving cellular network has exhausted its frequency resources it can ask additional frequency resources from the other co-locating cellular networks.

### FIELD OF THE INVENTION

The invention relates to a wireless communication system that uses shared radio resources. In the wireless communication system two or more network operators share a common medium for contention based resource requests, e.g., common uplink time slot in the same frequency band. The operators can offer channel resources to other operators according to the access requests if they have excess capacity.

### BACKGROUND OF THE INVENTION

Current mobile radio systems utilize mainly licensed frequency bands. Examples of them are GSM (Global System for Mobile communications) and UMTS (Universal Mobile Telecommunications System). There are also systems that operate at shared unlicensed bands, for example WLAN (Wireless Local Area Network). However, there is not really dynamic co-operation between different networks or network operators. An exception is roaming in which, however, the network coverage areas of the operators are not overlapping.

Conventionally, every wireless network is assigned a fixed portion of the spectral resources. This is depicted in FIG. 1 where an exemplary operator M and another operator N both have got a fixed frequency band from total frequency band, reference 11 for operator M and reference 12 for operator N. However, there is no interaction between the operators M and N and thus frequency resource borrowing from another operator is not possible. This kind of frequency allocation system performs well in the situations, where resource demands are relatively static as a function of time. However, a spectrum usage need of a particular wireless network may vary in time and space which can cause lack of resources in the other wireless network while there are excess resources in another wireless network.

The spectrum sharing schemes guaranteeing inter-operator interference free assignments involve easily extensive inter-operator coordination, resulting in relatively slow spectrum assignment adaptation. It is expected that future wireless communication networks may no longer have dedicated or licensed spectrum allocations for different operators due to increasing data rate demands and restricted frequency bands. Therefore, the co-located network operators will be envisioned to share a common broadband frequency band. This calls for coordination and need for flexible capacity balancing between the network operators, based on the traffic needs in each wireless network.

A shared frequency band of several network operators leads every now and then to a contention situation. The contention problem can be solved by utilizing for example ALOHA or CSMA (Carrier Sense Multiple Access) or their enhancements. However, these methods suffer from access request collisions that reduce efficiency and increase delay due to the re-transmissions resulting from the access request collisions.

For reducing above-mentioned packet collisions complementary code sets have been proposed to be utilized as user contention resolution codes for random access packet systems (J. Zhu and A. 0. Fapojuwo, “A complementary code-CDMA-based MAC protocol for UWB WPAN system,” EURASIP Journal on Wireless Communications and Networking, volume 2005, pp. 249-259). Although utilization of complementary codes increases efficiency in processing access request bursts they as such do not solve the problem of the resource sharing between network operators.

### SUMMARY OF THE INVENTION

An object of the present invention is to obtain fast and simple resource reassignment offering co-located operators transmission resources they require at the cost of a small inter-operator and multi-access interference.

The object of the invention is achieved by a scheme, in which a certain fixed inter-operator interference-free portion of frequency resources is guaranteed to every network operator. On the other hand, a part of the frequency resources is allocated as a common resource to all co-located network operators. Therefore, in each network it is possible to request more user resources, for example in the up link, when the fixed frequency band is fully utilized by making a resource request concerning the shared frequency resource. Uplink resource requests originating from different users can lead to a contention of available frequency resources during RRM signalling (Radio Resource Signalling). The usage of complementary codes (CC) is utilized at the physical layer for contention resolution for sharing the frequency resources to different users in the common frequency band.

An advantage of the invention is that several network operators can flexible share a common frequency band on contention basis.

Another advantage of the invention is that it makes it possible to obtain fast and simple resource re-assignment offering every network operator the resources they require at the cost of a small inter-operator and multi-access interference.

Another advantage of the invention is that it is the allocation of resources can be done quickly compared to the prior art methods.

A further advantage of the invention is that resource sharing can be accomplished also in non-synchronized random access cases.

Yet another advantage of the invention is that a primary operator, which has lent its resources, has a priority to recall its borrowed resources to its own use with very low delay.

The idea of the invention is basically as follows: Each network operator releases an amount of commonly owned frequency resources if it can manage with either its fixed frequency band or a smaller part of the shared frequency band. The operator informs on free resources to other co-located operator(s) on contention basis. The primary operator, which has borrowed its resources, has a priority to recall the lent resources to its own use with very low delay. The resources released by the method are used for contention based communication by operator networks which temporarily have exhausted its own resources. The network topology is advantageously cellular topology with 2-4 co-located operators. Advantageously they use a same radio access technology and the operator base stations communicate within a common time domain superframe.

Resource request packets of co-locating network operators utilize advantageously orthogonal complementary codes at the physical layer of the communication link. The complementary codes have ideal auto- and cross-correlation properties that make perfect collision resolution of overlapping requests possible even in the asynchronous case like cellular uplink channel. Therefore, the complementary codes can differentiate various operators' resource request packets. A protocol overhead is kept minimal and there is no need for re-transmissions in resource requests, because the completely or partially overlapping packets can be resolved. This improves efficiency of the system in comparison to the pure random access contention (Aloha-type), specifically in heavily loaded networks.

Further scope of applicability of the present invention will become apparent from the detailed description given hereafter. However, it should be understood that the detailed description and specific examples, while indicating advantageous embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and accompanying drawings which are given by way of illustration only, and thus are not limitative of the present invention and wherein:

FIG. 1 shows a schematical representation of a frequency resource allocation of prior art;

FIG. 2 shows an embodiment of the invention where a part of frequency resources is shared with two network operators; and

FIG. 3a shows as an example of complementary codes;

FIG. 3b shows an interference free portion of the periodic correlation of the complementary codes of FIG. 3a;

FIG. 4 shows as an exemplary flowchart main steps of the method of the present invention;

FIG. 5 shows an exemplary network co-operation according to the invention; and

FIG. 6 shows an exemplary mobile terminal which can utilize the frequency sharing method according to the invention.

### DETAILED DESCRIPTION

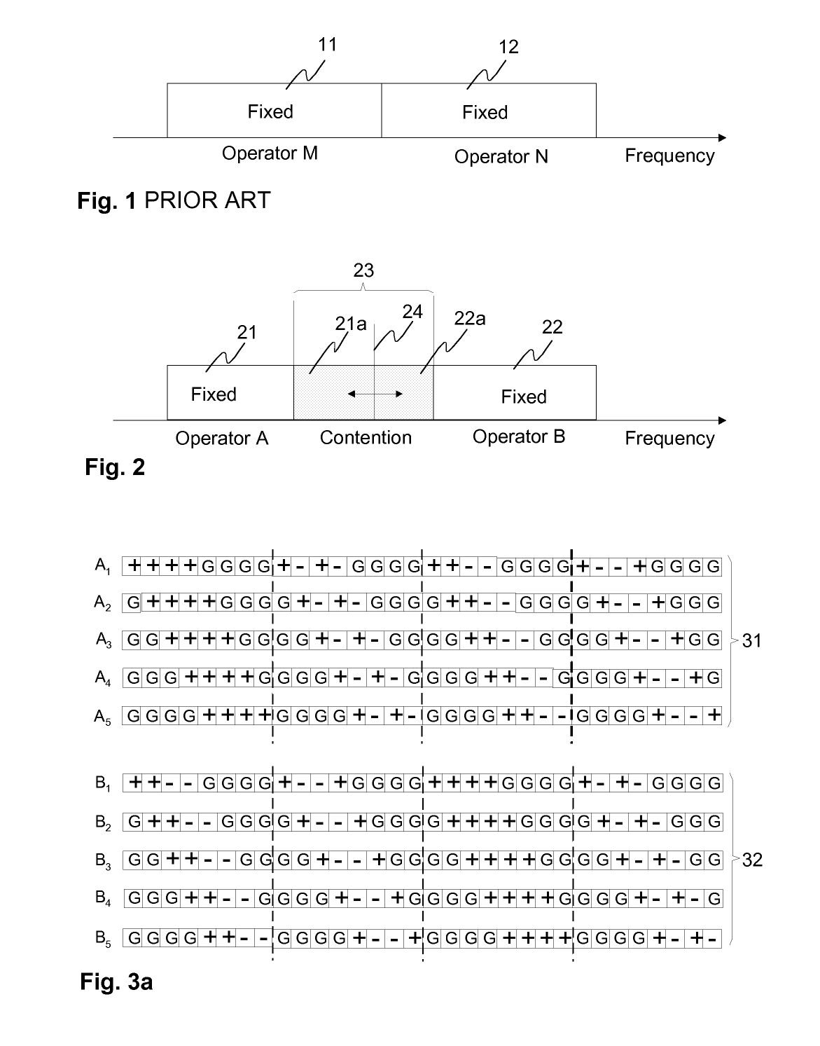

FIG. 1 was discussed in conjunction with the description of the prior art.

FIG. 2 illustrates a simplified example of the present invention. In FIG. 2 it is shown a frequency resource sharing strategy, where the two exemplary cellular operators, operator A and operator B, can trade at least a part of their unused frequency resources on contention access basis. This kind of dynamic approach is proper in cases, where operator loads vary significantly over time. Then overload and underutilization situations can be smoothed by flexibly trading resources between the co-locating operators.

In the example of FIG. 2 to operator A is allocated a fixed frequency band 21 and to operator B another fixed frequency band 22. The depicted frequency band 23 is common to the operators A and B. In FIG. 2 by line 24 is depicted how the common frequency band is shared between operator A and B at some point of time. Operator A has a supplementary frequency band 21a and operator B has a supplementary frequency band 22a.

How the common frequency band 23 is divided between operators A and B can vary very much in time. This is depicted by an arrow having two heads in the convention area 23. For example, if the operator B needs its supplementary frequency resources only a little and the other operator A has run out of its current frequency resources then unused resources of operator B can temporally be allocated to terminal devices of operator A. For accomplishing that, operator B signals to operator A that it can release some surplus of its frequency resources. After sharing the common frequency band in a new way the line 24 depicting the sharing of the frequency resources moves right in FIG. 2. When the overload situation in the network of operator A ends it gives up the borrowed frequency resources back to operator B. It should be noted that the re-allocation of resources according to the invention can be done in all cases, when one of the operators needs more resources for either uplink or downlink communication.

The above described frequency sharing can also be accomplished in cases where the service operator requesting frequency sharing has some frequency resources remaining which are allocated to it.

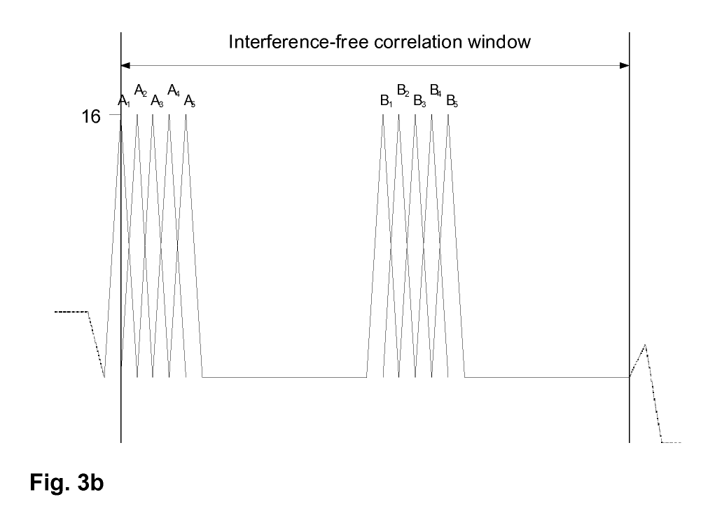

FIG. 3a depicts an example of one complementary code set, which is utilized in access channels of two cellular networks. FIG. 3a illustrates an example of the potential TDMA implementation for operator complementary code organization with two exemplary operators A and B. In the cellular network of operator A camp five exemplary terminal devices whose complementary codes are A₁-A₅. In the cellular network of operator B camp other five exemplary terminal devices whose complementary codes are B₁-B₅. The user access channels are made orthogonal by separating them from each other by time in the example of FIG. 3a.

In the depicted exemplary complementary codes sets symbol G denotes a guard chip. No transmission happens during it. For all practical purposes it can be regarded as “0”. FIG. 3a depicts an example of a system utilizing four chip guard time between the member codes. The required guard time is advantageously adjusted according to the overall timing uncertainties in the system. Assuming that the timing uncertainty is less than the duration of symbol G it is possible to separate ideally all transmissions encoded by A₁-A₅, reference 31, and B₁-B₅, reference 32. The separation of different transmissions can advantageously be done by a single receiver correlator or matched filter because all utilized codes A₁-A₅ and B₁-B₅ are phase-offset versions of the same code.

The present invention can be implemented advantageously also in an OFDM (Orthogonal Frequency-Division Multiplexing) or MC-CDMA (Multi-Carrier Code Division Multiple Access) based systems due to their inherent orthogonal sub-carrier structures. These systems offer required orthogonal sub-channels both in frequency and time domains.

FIG. 3b shows how complementary codes of FIG. 3a can be differentiated from each other by an exemplary correlator. In FIG. 3b the interference-free portion of the periodic correlation corresponds to the length of the depicted code in FIG. 3a. In FIG. 3b are shown as an example correlation peak of code A₁ and the sum of all other codes of FIG. 3a, i.e. A₂+A₃+A₄+A₅+B₁+B₂+B₃+B₄+B₅. Activity of all codes is demonstrated by ten completely resolvable correlation peaks A₁-A₅ and B₁-B₅. Each depicted correlation peak has a value of 16 which is the processing gain when the depicted complementary codes of FIG. 3a are utilized. A maximum code phase offset between operator codes of operator A and operator B is chosen, i.e. sixteen chips in the example of FIG. 3a.

Codes A₁-A₅ and B₁-B₅ in FIGS. 3a and 3b can be seen as examples of terminal specific codes. However, for large networks it may not be feasible to equip every terminal with own code because complementary code sets are small. In that case it is advantageous to use operator specific codes and utilize the whole interference free window for correlation peak separation for counting the simultaneous access requests.

It can be seen from FIG. 3b that two more operators utilizing the same complementary code set with different code phase offset could be added to the exemplary frequency sharing system of FIG. 3a. Of course with other complementary code sets and increased code lengths higher number of operators can be handled.

The size of the interference free complementary code set could be extended by increasing the guard time G and/or spreading code length or by including multiple code sequences in the complete complementary code set.

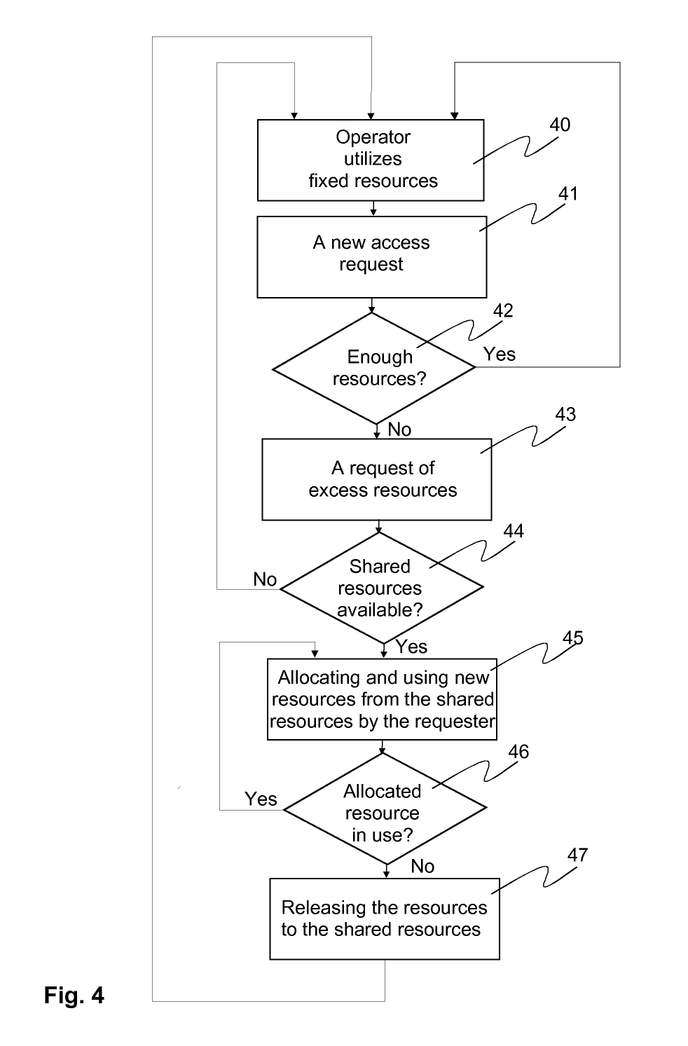

The main steps of the method according to the invention are shown as an exemplary flow chart in FIG. 4.

The frequency sharing process according to the invention starts in step 40 where the co-locating network operators utilize at least their own fixed frequency bands. Advantageously they can also utilize a part or the sharable frequency band. In step 41 one of the co-locating operators receives a new access burst from a terminal device from its own network. Advantageously the terminal device utilizes in its access burst a complementary code which it has got from the serving network operator. Advantageously all co-locating operators can correlate the access burst code which advantageously comprises a network specific code.

In one advantageous embodiment the complementary code comprises also a terminal specific code.

In step 42 the serving network operator checks if its resources are sufficient to establish the requested connection. If the resources are sufficient the process returns to step 40 where the serving network operator establishes the required connection to the terminal device utilizing available frequency resources.

If the serving network operator does not have enough frequency resources, or it for some reason wants more resources for its use in a case where some frequency resources are still remaining, it can request more frequency resources from the shared portion of the frequency resources in step 43. It signals the frequency resource request to the other co-locating network operators.

In step 44 the other co-locating network operators check their own usage of the shared frequency band. If also the other co-locating network operators utilize fully their own part of the shared portion of the frequency band then they signal about the condition to the network operator which has made the excess frequency resource request. In that case all co-locating network operators continue to utilize frequency resources which were allocated to them before the presented resource request.

If in step 44 at least one co-locating network operator signals that at least a certain part of the frequency resources allocated to it can be lend to the terminal device of another co-locating service operator then the network operator which has made the request for additional frequency resources directs the terminal device to use the released frequency band in step 45.

In step 46 it is every now and then checked if the established connection is still active. If it is active the terminal device is advantageously allowed to continue to use borrowed frequency band. If it is detected that the established connection has already been disconnected then in step 47 the network operator which had borrowed the frequency band signals to other co-locating network operators that it releases immediately the borrowed frequency band. After that the process returns to step 40 where all network operators utilizes their own frequency bands.

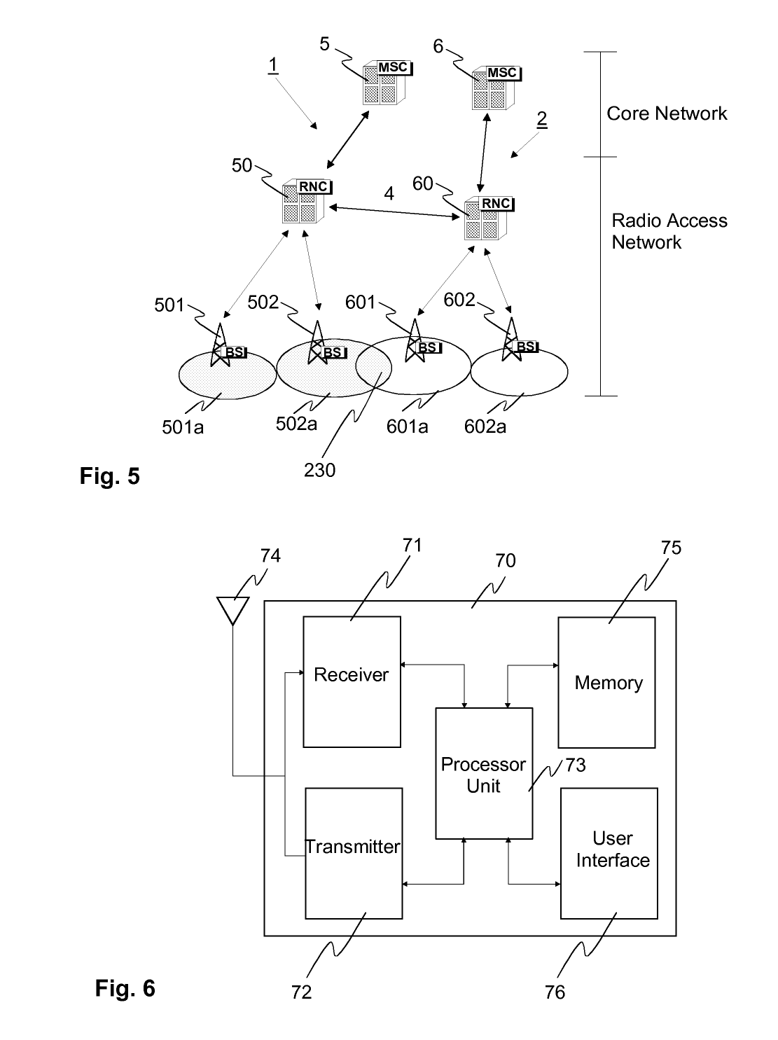

FIG. 5 shows a basic structure of two exemplary digital cellular systems 1 and 2. The depicted mobile communications networks comprise both their own core networks (CN) and one or more radio access networks (RAN). The core networks consist of various central systems which may offer various intelligent network services in addition to versatile communications possibilities. Both depicted core networks 1 and 2 comprise their own mobile services switching centers (MSC), references 5 and 6, and the associated transmission systems. The radio access networks are located between the core networks and mobile stations. First depicted radio access network comprises base stations BS, references 501, 502 and a radio network controller (RNC) 50. The depicted base stations 501 and 502 have a fixed connection to the radio network controller 50. The radio network controller 50 in turn has fixed connection to at least one core network node, in the depicted example mobile switching center 5.

Second depicted radio access network comprises also base stations BS, references 601, 602, and a radio network controller 60. The depicted base stations 601 and 602 have a fixed connection to the radio network controller 50. The radio network controller 60 in turn has fixed connection to at least one core network node, in the depicted example to mobile switching center 6.

A first radio access network comprises two exemplary base stations, references 501 and 502. The cell coverage of base station 501 is depicted by a circle 501a and the cell coverage of the base station 502 by a circle 502a.

A second radio access network comprises also two exemplary base stations, references 601 and 602. The cell coverage of base station 601 is depicted by a circle 601a and the cell coverage of the base station 602 by a circle 602a.

In one area 230 the radio access networks overlap. For example in that area 230 a common frequency band of both radio access networks can advantageously be accomplished.

In the depicted example of FIG. 5 the base stations 502 and 601 have advantageously ability to correlate all potential operator complementary codes. The function can be implemented for example by a proper correlator unit or proper matched filters in both base stations. They can be accomplished by utilizing proper software which is executed in a processor unit of the base station.

A decision to allocate anew a frequency band can be made advantageously in co-operation of radio network controllers 50 and 60. Signaling, between the mobile services switching centers, which is needed for allocating frequency band anew is depicted by an arrow 4 in FIG. 5. The frequency resource sharing can be advantageously accomplished by proper software installed in the radio network controllers 50 and 60.

FIG. 6 shows, by way of an example, the functional main parts of a terminal device 70 of a cellular network capable of utilizing the frequency sharing method according to the invention. The terminal device 70 can be, for example, a GSM, GPRS or UMTS terminal device.

The terminal device 70 uses an antenna 74 in the transmission and reception of signals with the serving cellular network. The receiver of the terminal device 70 is shown by reference 71. The receiver 71 comprises prior art means for all messages or signals to be received. The receiver 71 is capable of receiving signals on the fixed frequency band of the serving cellular network and also on the common frequency band of all co-locating operator networks.

Reference 72 denotes the transmitter of the terminal device 70. All the signal processing measures required, when operated with a cellular network, are advantageously performed by the transmitter 72. The terminal device 70 comprises also means connected to the transmitter 72 which provides a complementary code according to the invention to be included in an access burst.

In the terminal device 70 the central processing unit 73 controls operations of the transmitter and receiver. It controls also the memory 75, in which a complementary code required for sending an access burst according to the invention advantageously can be saved. The saved complementary code comprises at least an operator signature. In one advantageous embodiment the complementary code comprises also a device specific part besides the operator signature.

The terminal device 70 also comprises a user interface 76. It comprises at least a display and keyboard.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for reallocating frequency resources between co-located cellular networks (1, 2), the method comprising:
allocating (40) to each co-locating cellular network (1, 2) an own fixed frequency band (21, 22); and
allocating a frequency band (23) common to all co-locating cellular networks, characterized in that the method further comprises:
including in a terminal device access burst an access burst code of a serving cellular network (1, 2);
receiving and correlating (41) the access burst code of a terminal device in the co-locating cellular networks (1, 2); and
when the frequency resources of the serving cellular network (1, 2) are at least partly utilized then requesting (43) a temporal sub-frequency band from the common frequency band for the use of the terminal device; and
re-allocating (44, 45) from the common frequency band a sub-frequency band to the terminal device for the requested connection when there are re-allocable frequency bands.

2. The method according to claim 1 characterized in that the access burst code is a complementary code set (31, 32).

3. The method according to claim 2 characterized in that the complementary code set comprises a cellular network operator specific code.

4. The method according to claim 3 characterized in that complementary code set further comprises a cellular terminal (70) specific code.

5. A network arrangement for re-allocating frequency resources between co-located cellular networks (1, 2), the network arrangement comprising:
a means (50, 60) for allocating to each co-locating cellular network (1, 2) an own fixed frequency band; and
a means (50, 60) for allocating a frequency band common to the co-locating cellular networks,
characterized in that the network arrangement further comprises in each co-locating cellular networks:
a means for correlating an access burst code of a terminal device originating from one of the co-locating cellular networks (502a, 601a); and
a means (50, 60) for re-allocating from the common frequency resource a sub-frequency band to the terminal device when the frequency resources of the serving cellular network are at least partly utilized.

6. The network arrangement according to claim 5 characterized in that the access burst code is a complementary code set (31, 32).

7. The network arrangement according to claim 6 characterized in that the complementary code set comprises a cellular network operator specific code.

8. The network arrangement according to claim 7 characterized in that complementary code set further comprises a cellular terminal (70) specific code.

9. A cellular terminal (70) comprising:
a transmitter (72);
a receiver (71);
a processor unit (73); and
a memory (75),
characterized in that the cellular terminal further comprises a means for transmitting an access request comprising a complementary code set.

10. The cellular terminal according to claim 9 characterized in that the complementary code set comprises a cellular network (1, 2) specific code.

11. The cellular terminal according to claim 10 characterized in that the complementary code set further comprises a cellular terminal (70) specific code.

12. A computer readable medium encoded with software for re-allocating frequency resources between co-located cellular networks (1, 2), characterized in that the software comprises computer readable code for:
correlating an access burst code of a terminal device of a cellular network;
detecting when the frequency resources of the serving cellular network (1, 2) are at least partly utilized; and after that
requesting a temporal sub-frequency band from a common frequency band for the use of the terminal device; and
allocating on a contention bases a temporal frequency band from the frequency band common to the all co-locating cellular networks (1, 2) to the terminal device, which has sent the access burst.

13. The software according to claim 12, characterized in that the software comprises further computer readable code for correlating an access burst comprising a complementary code.

14. The software according to claim 13 characterized in that the complementary code comprises a cellular network (1, 2) specific code.

15. The software according to claim 14 characterized in that the complementary code further comprises a cellular terminal (70) specific code.
